(19) United States
(12) Patent Application Publication
(10) Pub. No.: US 2025/0279222 A1
(43) Pub. Date: Sep. 4, 2025

(54) PHYSICAL LAYER ASSET MANAGEMENT SYSTEMS AND DEVICES

(71) Applicant: Green Lambda Corporation, Norman, OK (US)

(72) Inventors: Mohammad H. Raza, Norman, OK (US); Ahmed Arsalan, Norman, OK (US); Jose Pats, Norman, OK (US); Sang A. Cooc, Norman, OK (US)

(21) Appl. No.: 19/069,165

(22) Filed: Mar. 3, 2025

Related U.S. Application Data
(60) Provisional application No. 63/560,246, filed on Mar. 1, 2024.

(51) Int. Cl. H01B 7/36

(52) U.S. Cl. CPC H01B 7/368

(57) ABSTRACT

A data network asset management system includes a plurality of network devices, a plurality of cables and one or more AAE devices. The cables are connected at least between a first network device of the plurality of network devices and a second network of the plurality of network devices. The one or more AAE devices are removably connected to each of the plurality of cables. Each AAE device includes a body and a locking member releasably secured to the body and movable relative to the body. The body includes an outer wall and a hollow center. The outer wall of the body includes a body opening extending from the first end of the body to the second end of the body. The locking member includes an outer wall and a hollow center. The outer wall of the locking member includes a locking member opening extending from a first end of the outer wall of the locking member to a second end of the outer wall of the locking member. When the locking member is moved relative to the body or the body is moved relative to the locking member, the body opening can be aligned with the locking member opening to form a cable opening in the AAE device. The cable opening is configured to permit at least one of the plurality of cables to pass through the body outer wall and the locking member outer wall into the hollow center of the body and the hollow center of the locking member.

### CROSS REFERENCE TO RELATED APPLICATIONS

The present disclosure is based on and claims benefit from co-pending U.S. Provisional Application No. 63/560,246 filed Mar. 1, 2024 entitled “Physical Layer Asset Management Systems and Devices” the entire contents of which are incorporated herein by reference.

### TECHNICAL FIELD

The present application relates generally to physical layer network assets, including cables, typically used in data or communication networks or datacenters, and more particularly to tracking, documenting and asset management of physical layer network assets.

### DESCRIPTION OF THE RELATED ART

Data or communication network or datacenter devices communicate with one another using wired or wireless connections. The common physical equipment that links data or communication network or the datacenter devices is the cable. The term cable here includes copper cables, fiber cables, power cables or any other type of cables. A data or communication network or a datacenter in this context refers to a system of network and compute devices connected by cables. Cables link network devices together, such as servers to switches, switches to routers, routers to firewalls, etc. As important as cables are to data or communication networks and datacenters, they are usually invisible to current digital network monitoring systems. In most cases, the only way to monitor or track cables and other devices is by manually monitoring and tracking such devices. There are several types of fiberoptic cable assemblies that are commonly used in the industry. For example, there are cable assemblies with a paired fiberoptic LC connector assembly at each end of the fiberoptic cable assembly. There are cable assemblies with a multi-fiber cable assembly that includes multi-fiber connector, e.g., a Multi-fiber Push On (MPO) or a Multifiber Termination Push on/Push off (MTP) connector at each end of the multi-fiber cable. There are cable assemblies that include a multi-fiber connector, e.g., an MPO connector, on one end of a multi-fiber cable and a plurality of single fiber connectors, e.g., single LC connectors and/or duplex LC connectors, on the other end of the multi-fiber cable. There are cable assemblies that include an RJ45 connector attached to each end of a multi-medium copper cable. There are cable assemblies that include a power cable and power connectors at each end of the power cable. There are cable assemblies that include coaxial cable with connectors at each end of the coaxial cable.

As noted, the most popular method in the industry to track cables in a data or communication network or a datacenter is through manual surveys, and then storing the collected information on spreadsheets. Due to the manual nature of this method, cable tracking in a data or communication network or a datacenter is seldom done as it is a very tedious and expensive task without any reliable level of accuracy of the information stored. This is due to the fact that it is difficult to track cables that traverse a cable tray with hundreds of other cables and where the cable tray may be located under a raised floor or elevated in the data or communication network or the datacenter.

In data networks or datacenters, often the cables connect devices together, for example a server is connected to a switch through cables. Although the server can be connected to the switch in a direct manner, this is not typical in data or communication networks and datacenters. People working in this industry know that the connection between two devices, such as the server and switch mentioned above, is not direct. For example, a cable from a server can be connected to a first patch panel or other distribution device. For the ease of description, the distribution devices contemplated by the present disclosure may also be referred to herein as a “patch panel” in the singular or “patch panels” in the plural. A second cable can then be connected from the first patch panel to a second patch panel, and a third cable can be connected between the second patch panel and a third patch panel. A fourth cable can then be connected between the third patch panel and the switch. This seemingly single connection from a server to a switch may in fact have one, two, three or more patch panels in between. As is readily apparent, the number of overall cables in a data or communication network or the datacenter can become very large very quickly so that the need to manage (e.g., monitor and track) the cables in a network or datacenter becomes very important.

Previous attempts to electronically track cables in data networks and datacenters have failed in that they are not capable of tracking all cables from end-to-end in the data or communication network or the datacenter. As a result, the unreliable, time consuming and expensive manual tracking and storing information into a spreadsheet is still used. The above example of tracking the cables between a server and a switch demonstrates the challenges in monitoring and tracking cables in a network or datacenter. The cables in this example may be fiber optic cables or copper cables. However, the problem addressed by the present disclosure relates to all types of cables, including fiber optic cables and copper cables that provide connections between devices within, for example, a data or communication network, or a datacenter. The problem addressed by the present disclosure also relates to all types of cables that provide power to devices or transport power from one location to another.

The present disclosure provides software management systems and electronic devices for end-to-end tracking of assets, including cables, within a particular environment, such as a data network, a communication network or a datacenter.

### SUMMARY OF THE INVENTION

The present disclosure is directed to systems and devices for physical layer asset management of data networks, communication networks and/or datacenters, and to devices that can be used with such physical layer asset management systems. Henceforth, “data network,” “communication network,” “network” and “datacenter” will be interchangeable for the purpose of the present disclosure, and may also be referred to herein as “data network” in the singular and “data networks” in the plural. In addition, the physical layer asset management systems of the present disclosure may also be referred to herein as the “asset management system” or the “management system.” The devices that can be used with the asset management systems may be referred to herein as an attachment assembly with electronics (AAE). The AAE can be installed on any type of datacenter device, any type of network device and/or any type of cable assembly within a data network. Non-limiting examples of datacenter devices include cabinets, racks and raceways. Non-limiting examples of network devices include patch panels, routers, firewalls, servers, switches, storage units and appliances. Non-limiting examples of cable assemblies include copper cable assemblies (e.g., ethernet cables), fiberoptic cable assemblies, coaxial cable assemblies and electrical power cable assemblies. Datacenter devices, network devices and cable assemblies can be collectively referred to herein as “datacenter hardware.” Cable assemblies include one or more cables and one or more terminations at each of the cable. A cable in a cable assembly may be a single-medium cable having single medium within a cable jacket, or the multi-medium cable having more than one medium within a cable jacket. As an example, a single medium fiber optic cable includes a single fiber strand within the cable jacket. As another example, a multi-medium fiber optic cable includes many fiber strands, e.g., 8, 12, 16, 24, 48 or 72 fiber strands, within the cable jacket. It is noted that a multi-medium fiber optic cable may also be referred to as a multi-fiber cable. Non-limiting examples of fiber optic cable assemblies include fiber optic cable assemblies that include a multi-fiber cable and a multi-fiber connector at each end of the multi-fiber cable, fiber optic cable assemblies that include a multi-fiber cable, a multi-fiber connector at one end of the multi-fiber cable and a plurality of single fiber connectors at the other end of the multi-fiber cable, and fiber optic cable assemblies that include a single fiber cable and a single fiber connector at each end of the single fiber cable.

The AAE is configured to store information relative to the datacenter hardware to which it is attached. For example, AAE's attached to cable assemblies may store information relative to the cable, the terminations, e.g., the connectors, at the ends of the cable, the location of the cable and/or the location of the datacenter device or network device the end of the cable is connected to. An adapter or a mobile device located close to the AAE can then read the information stored on the AAE. Using the stored information and the location of the AAE, a correlation between the AAE and a datacenter device, network device or function can be established. A device management system (DMS) that communicates directly with the AAE or that communicates with an adapter or a mobile device in communication with DMS processes the AAE information from one or more AAEs for tracking, monitoring and security applications. The AAE includes a unique identity (ID) to identify the datacenter hardware to which the AAE is attached, and in the example of cable assemblies to identify a cable assembly or to identify an end of the cable of the cable assembly. For example, a single AAE can be attached to a cable assembly, or two AAEs can be attached to a cable assembly with one AAE attached near to each end of the cable, or more than two AAEs can be attached to a cable assembly to identify different areas of the cable assembly. The ID of the AAE is preferably readable using electronic means including wired and wireless electronic connections.

For ease of description, the function of the AAE will be explained relative to a cable assembly, specifically a fiberoptic cable assembly. However, as set forth above, the AAE can be attached to any datacenter hardware. Using AAEs provides an easy and cost-effective way to digitalize a cable assembly or other datacenter hardware. The AAE has one or more storage devices included in it and these storage devices can be of the EPROM type, which is a programmable, erasable, or non-erasable device in the form of an integrated circuit or IC, also commonly known as a chip, or it can be a radio frequency identification device also known as RFID tag, which can also be in the form of a chip. However, other storage devices may be included in the AAE. The unique ID for each AAE can be stored in the storage devices of the AAE. The unique ID can be a serial number or other type of identifier that can then be read electronically. The AAE may also have an asset association established with the datacenter hardware to which it is attached. In this context, asset refers to any datacenter hardware. To make datacenter hardware identification easier, AAEs can be associated with datacenter hardware through the device management system (DMS). The DMS allows users to quickly identify any datacenter hardware being managed by the asset management system. The AAE is able to communicate with an adapter or a mobile device located close to the AAE such that the DMS can track and monitor datacenter hardware to which the AAE is attached. As stated above, there can be one or more AAEs attached to datacenter hardware and all AAEs can be tracked at the same time by the DSM.

The systems and devices contemplated by the present disclosure combine datacenter hardware, and one or more AAEs, one or more AAE adapter modules and associated hardware communication devices, and the DMS to improve the efficiency of tracking and monitoring of, for example, datacenter hardware.

### BRIEF DESCRIPTION OF THE DRAWINGS

To further clarify the above and other advantages and features of the subject matter of this patent specification, specific examples of embodiments thereof are illustrated in the appended drawings. It should be appreciated that these drawings depict only illustrative embodiments and are therefore not to be considered limiting of the scope of this patent specification or the appended claims. The subject matter hereof will be described and explained with additional specificity and detail through the accompanying drawings in which:

FIG. 1 is a perspective view of an attachment assembly with electronics (AAE) according to the present disclosure and a cable positioned within the AAE, illustrating an opening in the body of the AAE obstructed by a rotated locking member of the AAE;

FIG. 2 is a partially exploded perspective view of the AAE of FIG. 1, illustrating the locking member inserted into the body of the AAE, with the AAE in an open position where an opening in the locking member is aligned with the opening in the body so that an opening is created in the AAE permitting a fiber optic cable to be inserted into the AAE;

FIG. 3 is an exploded perspective view of the AAE of FIG. 2;

FIG. 4 is a perspective view of the AAE of FIG. 1 with the opening in the AAE in an open position, and illustrating the fiber optic cable being inserted into the opening in the AAE, and illustrating additional AAE's staged for insertion onto individual fibers of the fiber optic cable;

FIG. 5 is a perspective view of the AAE and the LC fiber optic cable of FIG. 4, illustrating the locking member of the AAE being rotated to secure the AAE onto the cable;

FIG. 6 is a perspective view of another exemplary embodiment of the AAE of the present disclosure, illustrating a body and a locking member;

FIG. 6A is a cross-sectional view of the AAE of FIG. 6 taken from line 6A-6A;

FIG. 7 is an exploded perspective view of the AAE of FIG. 6, illustrating the locking member separated from the body;

FIG. 8 is a partially exploded perspective view of the AAE of FIG. 6, illustrating directions of movement of the locking member relative to the body;

FIG. 9A is a rear perspective view of the locking member of the AAE of FIG. 7;

FIG. 9B is a front perspective view of the locking member of the AAE of FIG. 7;

FIG. 10A is a front perspective view of the body of the AAE of FIG. 7, illustrating an electronic readable storage device and an RF Identification (RFID) device separated from the body of the AAE;

FIG. 10B is a rear perspective view of the body of the AAE of FIG. 10A, illustrating the electronic readable storage device and RFID device attached to the body of the AAE;

FIG. 11A is a side perspective view of another exemplary embodiment of the AAE according to the present disclosure, illustrating a cable being inserted into the AAE and a locking member of the AAE and staged to tighten the cable within the body of the AAE;

FIG. 11B is a side perspective view of the AAE OF FIG. 11A, illustrating the cable inserted into the AAE and the locking member of the AAE rotated to tighten the cable within the body of the AAE;

FIG. 12A is a side perspective view of another exemplary embodiment of the AAE according to the present disclosure, illustrating the locking member in the closed position and a toggling button that when activated can tighten the cable within the body of the AAE;

FIG. 12B is a cross-sectional view of the AAE of FIG. 12A taken along line 12B-12B, illustrating the toggling button in an at rest position;

FIG. 12C is the cross-sectional view of the AAE of FIG. 12B, illustrating the toggling button in an activated position;

FIG. 13A is a cross-section view of the body of the AAE of FIG. 10A taken from line 13A-13A, illustrating the readable electronic storage device and the RFID device removed from recesses in the body of the AAE;

FIG. 13B is a cross-section view of the body of the AAE of FIG. 10B taken from line 13B-13B, illustrating the readable electronic storage device and the RFID device within the recesses in the body of the AAE;

FIG. 13C is a partial cross-section view of the AAE similar to FIG. 6, illustrating the mating of the locking member of the AAE to the body of the AAE;

FIG. 14 is a perspective view of another exemplary embodiment of the AAE according to the present disclosure, illustrating a body and one or more hooks that affix a cable to the body, where the hooks are spring actuated that open when pressed and close via spring action;

FIG. 15 is a perspective view of another exemplary embodiment of the AAE according to the present disclosure, illustrating a body and a locking member coupled to the body with readable electronic storage and/or RFID devices attached to the locking member and associated electrical connections to electrical contacts on an exterior of the body and the locking member;

FIG. 16 is a perspective view of the AAE of FIG. 25, illustrating the AAE can communicate with a computer via the contacts or via a wireless connection;

FIG. 17 is a perspective view of another exemplary embodiment of the AAE according to the present disclosure, illustrating the electrical connections to the contacts on an inside of the body of the AAE;

FIG. 18 is a perspective view of another exemplary embodiment of an AAE according to the present disclosure similar to FIG. 1, illustrating one or more indicators positioned on an exterior of either the body or locking member of the AAE;

FIG. 19 is a perspective view of another exemplary embodiment of an AAE according to the present disclosure similar to FIG. 6, illustrating one or more indicators positioned on an exterior of either the body or locking member of the AAE;

FIG. 20 is a perspective view of another exemplary embodiment of an AAE according to the present disclosure similar to FIG. 6, illustrating the readable electronic storage and/or the RFID devices positioned with recesses in the body of the AAE, one of more indicators positioned on an exterior of either the body or locking member of the AAE, and a release button accessible from an exterior of the body of the AAE and extending into an interior of the body;

FIGS. 21A-21D illustrate operational views for attaching the AAE of FIG. 20 to a cable, illustrating the AAE being attached to the cable, inserting the locking member into the body of the AAE and rotating the locking member relative to the body to attached the AAE to the cable;

FIG. 22 is a perspective view of an exemplary embodiment of a cable tracking chassis according to the disclosure with a front cover removed;

FIG. 23 is an enlarged perspective view of a portion of a top tray of the cable tracking chassis of FIG. 22 taken from detail 23, illustrating a portion of a fiber patching cassette with a paired LC connector attached to an adapter of the fiber patching cassette and an AAE attached to a cable and mounted to an exemplary embodiment of an AAE adapter;

FIG. 24 is an enlarged perspective view of a portion of an adapter board assembly of FIG. 23 taken from detail 24 and illustrating the AAE adapter and one or more electrical contacts within the adapter;

FIG. 25 is a block diagram of an exemplary embodiment of a network asset management system according to the present disclosure;

FIG. 26 is a block diagram of an exemplary embodiment of a device management system according to the present disclosure;

FIGS. 27A and 27B are schematic representations in which an AAE of the present disclosure can interact with the network asset management system of the present disclosure;

FIG. 28 is a schematic representation showing how AAE information from one or more AAEs according to the present disclosure can be used in the network asset management system of the present disclosure;

FIG. 29 is a schematic representation of another exemplary embodiment showing how AAE information from one or more AAEs according to the present disclosure can be used in the network asset management system of the present disclosure;

FIG. 30 is a schematic representation of another exemplary embodiment showing how AAEs of the present disclosure can be tracked with the device management system of the present disclosure;

FIG. 31 is a schematic representation of another exemplary embodiment showing how AAEs of the present disclosure can be tracked with the device management system of the present disclosure;

FIG. 32 is a schematic representation of another exemplary embodiment showing how AAEs of the present disclosure can be tracked with the device management system of the present disclosure;

FIG. 33 is a schematic representation of an exemplary embodiment showing how the device management system of the present disclosure can activate or deactivate one or more indicators on one or more AAEs of the present disclosure;

FIG. 34 is a schematic representation of an exemplary embodiment showing how the device management system of the present disclosure can report information to end users using a reporting module;

FIG. 35 is a schematic representation of an exemplary embodiment showing how the device management system of the present disclosure can notify end users using a notification module; and

FIG. 36 is a schematic representation of an exemplary embodiment showing how the device management system of the present disclosure can detect anomalies using an anomaly detection module.

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all such details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

Generally, the present disclosure is related to physical layer asset management systems. For ease of description, the physical layer asset management systems may also be referred to herein as the “asset management system” or the “management system.” The asset management system may include one or more attachment assembly (AA) adapters, attachment assemblies with electronics (AAE) and/or software that can communicate with each AA adapter and AAE independently or at the same time. The AAEs can be attached to many kinds of datacenter hardware. For cable assemblies, the AAEs can be attached or affixed to the ends of the cable assemblies and/or the AAEs can be attached or affixed to the cable assemblies at a point along the length of the cable assembly.

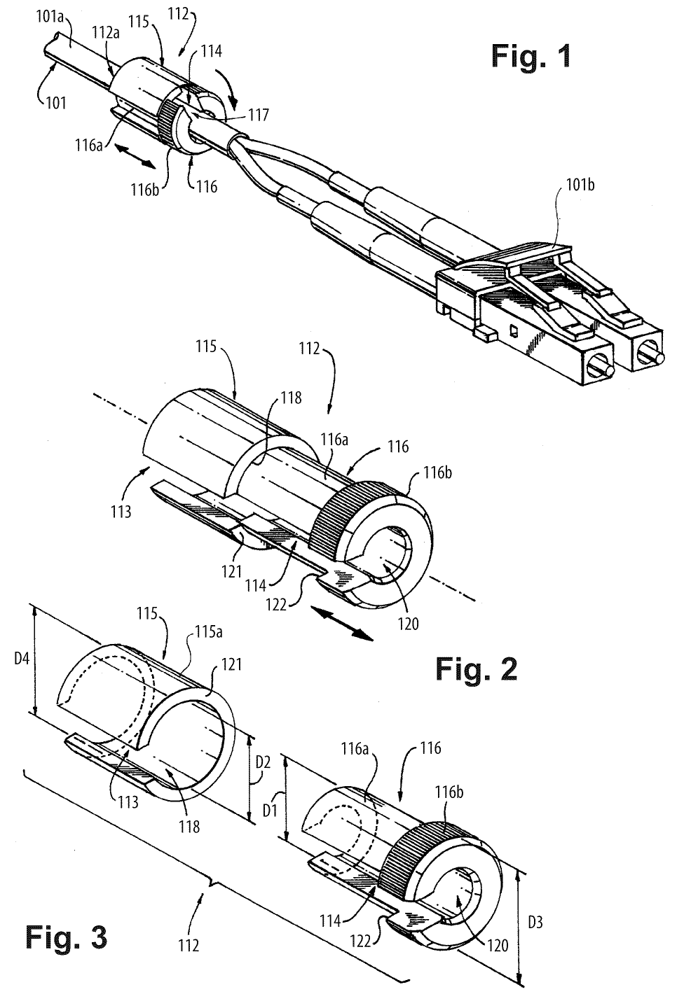

For ease of description, the asset management system, the AAEs and the AA adapters according to the present disclosure are described herein for use with fiberoptic cables. However, the AAE's and AA adapters can be used with other datacenter physical layer hardware. Referring now to FIGS. 1-3, an exemplary embodiment of an AAE according to the present disclosure is shown. The AAE 112 includes a body 115 and a locking member 116. In this exemplary embodiment, the body 115 interacts with the locking member 116, such that the locking member 116 fits within the body 115 and is rotatable relative to the body. In this exemplary embodiment, the body 115 is cylindrical member having an outer wall and a hollow interior portion. However, the present disclosure contemplates that the body 115 may be a square, rectangular, oval, elliptical or other shaped member. The body 115 includes a slot 113 extending from one end of the body to another end of the body defining an opening that is configured and dimensioned to permit a cable 101a, e.g., a fiber optic cable, to pass from an exterior of the body 115 to the hollow interior portion of the body. The slot 113 may be a longitudinal slot as shown in FIGS. 2 and 3. In this exemplary embodiment, the locking member 116 is cylindrical member having an outer wall and a hollow interior portion. However, the present disclosure contemplates that the locking member 116 may be a square, rectangular, oval, elliptical or other shaped member. The locking member 116 includes a slot 114 extending from one end of the locking member 116 to another end of the locking member 116 so that an opening that is configured and dimensioned to permit a cable 101a, e.g., a fiber optic cable, to pass from an exterior of the locking member 116 to the hollow interior portion of the body. The slot 114 may be a longitudinal slot as shown in FIGS. 2 and 3. The outer diameter “D1” of at least a first portion 116a of the locking member 116 is preferably less than an inner diameter “D2” of the body 115 so that the portion 116a of the locking member 116 can fit at least partially within the body 115 as shown in FIGS. 2 and 3. A second portion 116b of the locking member 116 may have an outer diameter “D3” that is greater than the outer diameter “D1” of the first portion 116a of the locking member 116. Preferably, the outer diameter “D3” of the second portion 116b is at least the same as the outer diameter “D4” of the body 115.

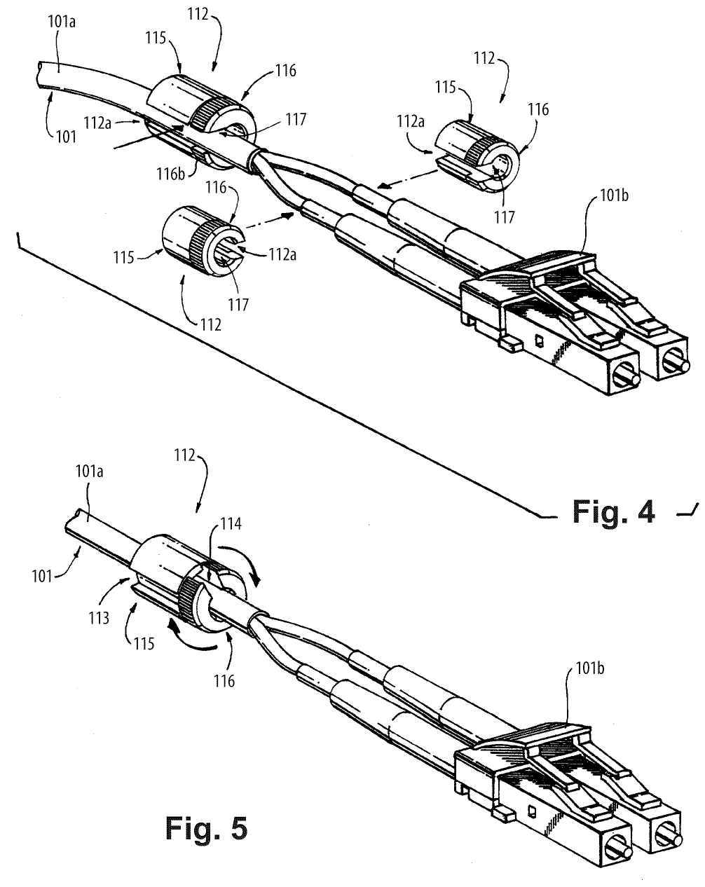

When the locking member 116 is mated to the body 115, the AAE 112 is formed. When the body 115 is rotated relative to the locking member 116 (or vice versa), so that the slots 113 and 114 are aligned, as shown in FIGS. 2 and 3, an opening 112a is formed in the AAE 112, seen in FIG. 4. The opening 112a is configured and dimensioned to allow one or more cables 101a, e.g., fiber optic cables, to be inserted through the slots 113 and 114 into the hollow portion of the AAE 112, as shown in FIG. 4.

Referring to FIGS. 4 and 5, operational steps to lock an AAE 112 onto a cable assembly 101, e.g., a fiber optic cable assembly, are shown. Initially, a cable 101a, e.g., a fiber optic cable, of the cable assembly 101 is inserted into the opening 112a of the AAE 112 so that the cable 101a is within the hollow portion 117 of the AAE 112. Then, either the body 115 can be rotated relative to the locking member 116 or the locking member 116 can be rotated relative to the body 115. For the purpose of the present disclosure the locking member 116 is rotated relative to the body 115 causing the slots 113 and 114 to begin to move out of alignment, as shown in FIG. 5. When the locking member 116 is sufficiently rotated so that the slots 113 and 114 are no longer in alignment, the cable 101a is held within the hollow portion 117 of the AAE 112, as shown in FIGS. 1 and 5. More specifically, by having the slots 113 and 114 out of alignment, the opening 112a in the AAE is blocked by the first portion 116a of locking member 116, as seen in FIG. 5. As shown in FIG. 3, the body 115 includes a hollow inner portion 118 that extends from one end of the body 115 to the other end of the body, and the slit 113 extends from one end of the wall 115a of the body 115 to the other end of the wall 115a of the body 115. The locking member 116 includes a hollow inner portion 120 that extends from one end of the locking member 116 to the other end of the locking member, and the slit 114 extends from one end of the wall of the first portion 116a of the locking member 116 to the other end of the wall of the second portion 116b of the locking member 116. As described above, the locking member 116 is configured to fit within the hollow inner portion 118 of the body 115 to form the AAE 112, as shown in FIG. 2. The body 115 and the locking member 116 may be mechanically held together such as by using one or more lips or ridges position on the interior wall surface of the body 115 and one or more corresponding notches on the exterior wall surface of the first portion 116a of the locking member 116. In another embodiment, the body 115 and the locking member 116 may be mechanically held together using one or more lips or ridges position on the exterior wall surface of the first portion 116a of the locking member 116 and one or more one or more corresponding notches in the interior wall surface of the body 115.

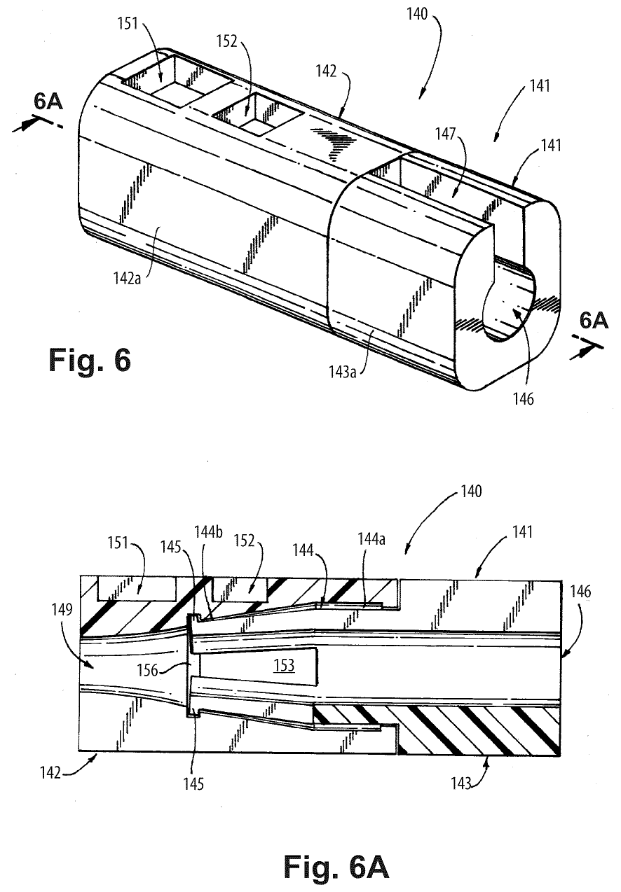

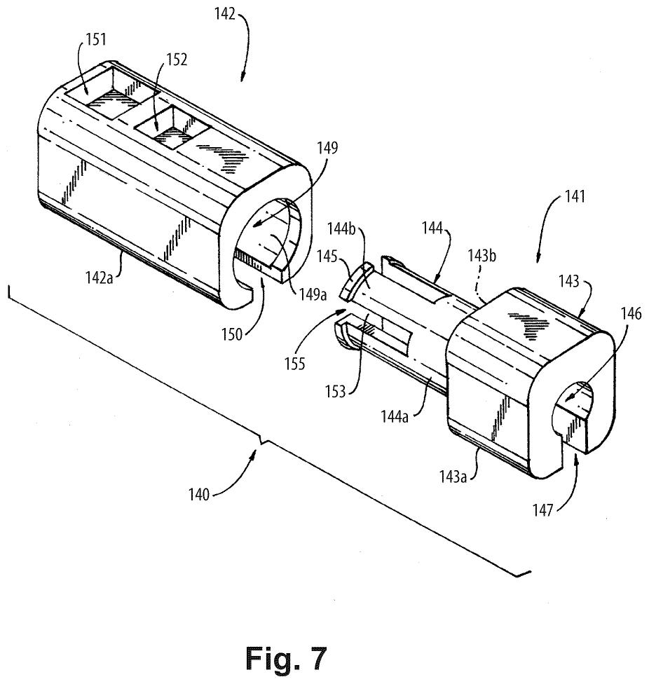

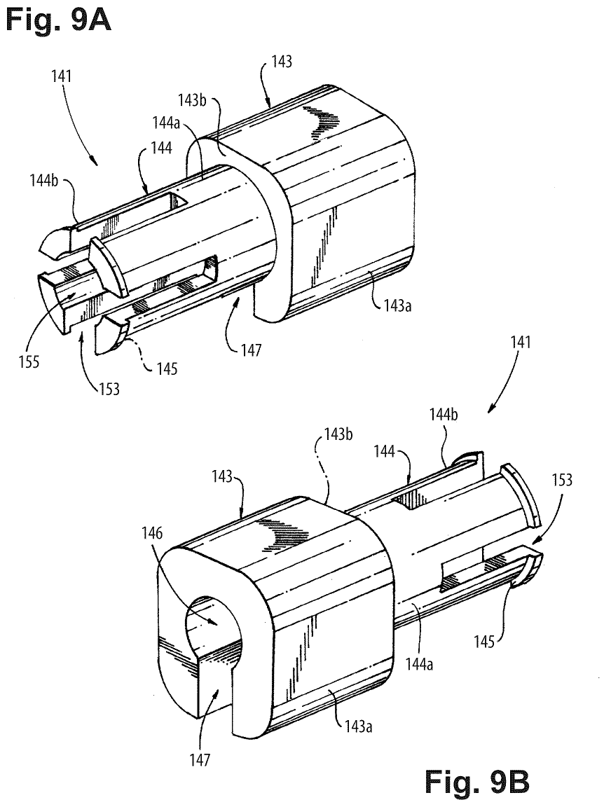

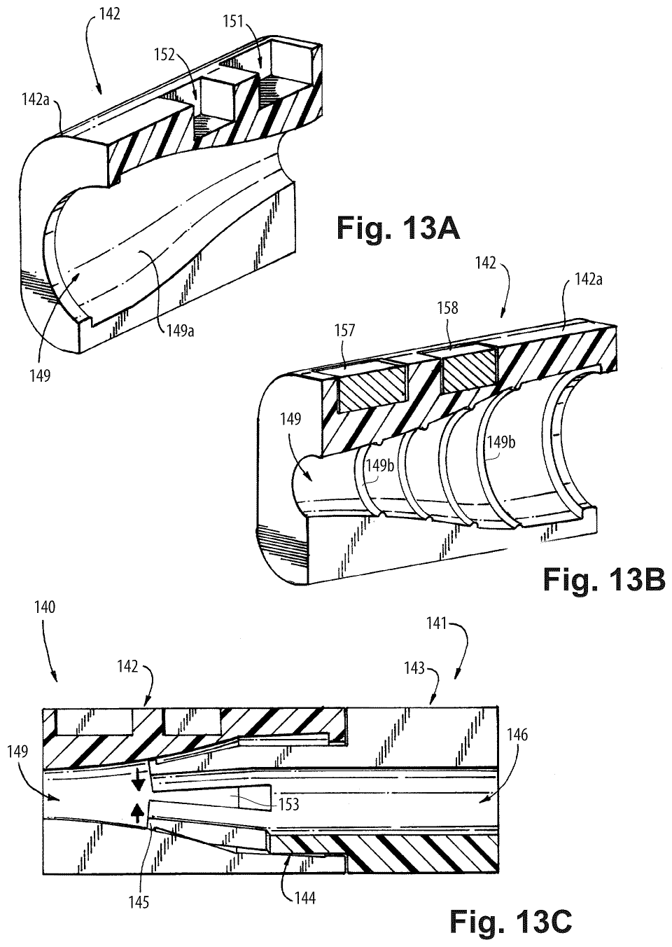

Referring to FIGS. 6-10B, another exemplary embodiment of an AAE according to the present disclosure is shown. In this exemplary embodiment, the AAE 140 includes a locking member 141 and a body 142. The locking member 141 includes a first portion 143 and a second portion 144. The first portion 143 and the second portion 144 may be any shaped member, including a shaped member having square shaped cross-section, a rectangular shaped cross- section, a circular shaped cross-section and an oval shaped cross-section. In the embodiment shown, the first portion 143 is a cube shaped member having an opening 146 extending therethrough and a slot 147 extending along a length of a wall of the first portion 143 from an exterior surface 143a of the first portion 143 to the opening 146, seen in FIG. 7. The slot 147 defines an opening that is configured and dimensioned to permit a cable 101a, e.g., a fiber optic cable, to pass from an exterior of the locking member 141 to the hollow interior portion of the locking member 141 defined by opening 146. The second portion 144 is a cylindrical shaped member as a first end 144a that may be integrally or monolithically formed into one end 143b of the first portion 143 and a second end 144b that is a free end, seen in FIG. 7. The present disclosure also contemplates that the first end 144a of the second portion 144 may be secured to the end 143b of the first portion 143 using, for example, welds, adhesives and/or mechanical fasteners, such as snap fit connections. The second portion 144 also include an opening 155 that is aligned with the opening 146. The second end 144b of the second portion 144 may include one or more fingers 144d separated by one or more slots 153 configured so that when the second portion 144 is inserted into the body 142, the fingers 144d can flex, as shown in FIG. 13C, so that the second end 144b fits within the body 142 as described below. Each finger 144d may include one or more lips or ribs 145 that can be used to couple the locking member 1412 to the body 142 and/or to flex the fingers 144d.

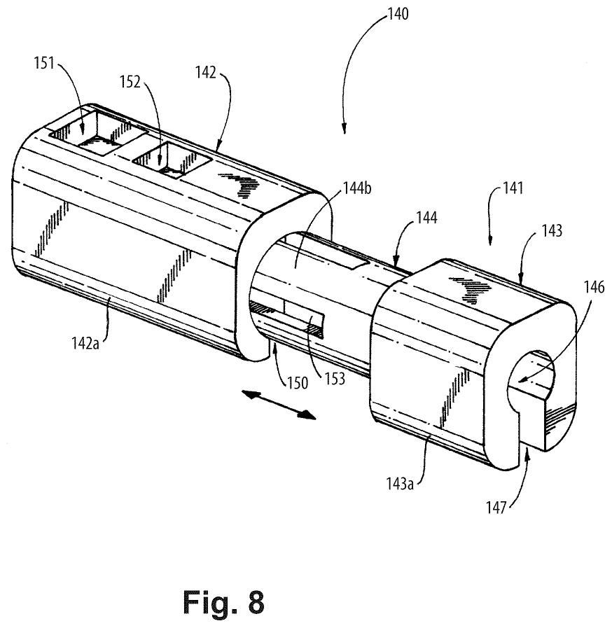

The body 142 may be any shaped member, including a shaped member having square shaped cross-section, a rectangular shaped cross-section, a circular shaped cross-section and an oval shaped cross-section. In the embodiment shown, the body 142 is a three dimensional rectangular shaped member having hollow inner portion defined by opening 149, seen in FIGS. 6A and 7, extending therethrough and along a length of the body 142. The body 142 also includes a slot 150, seen in FIG. 7, extending along a length of the body 142 from an exterior surface 142a of the body 142 to the opening 149. The slot 150 defines an opening that is configured and dimensioned to permit a cable 101a, e.g., a fiber optic cable, to pass from an exterior of the body 142 to the hollow interior portion of the body 142 defined by opening 149. The opening 149 is configured and dimensioned to receive the second portion 144 of the locking member 141. A wall 149a, seen in FIG. 7, of the opening 149 may include one or more notches or channels 156, seen in FIG. 6A, configured to receive the one or more lips or ribs 145 of the second portion 144 of the locking member 141 to couple or interlock the locking member 141 to the body 142. In an exemplary embodiment, the one or more notches or channels 156 includes one notch or channel 156 that corresponds to one of the one or more lips or ribs 145 so that when the locking member 141 is rotated, the one or more lips or ribs 145 can be rotated in and out of different notches or channels 156. In another exemplary embodiment, the one or more notches or channels 156 is a single notch or channel 156 so that the one or more lips or ribs 145 can fit within the notch or channel 156 and rotate within the notch or channel 156 when the locking member 141 is rotated. In another embodiment, the one or more lips or ribs 145 fits into one or more grooves in the body 142 so that as the locking member 141 is pushed into the body 142 the locking member 141 can slide back and forth, as seen by the arrow 30 in FIG. 8, with a snug fit, so that the one or more lips or ribs 145 prevent the locking member 141 and the body 142 from unintentionally decoupling.

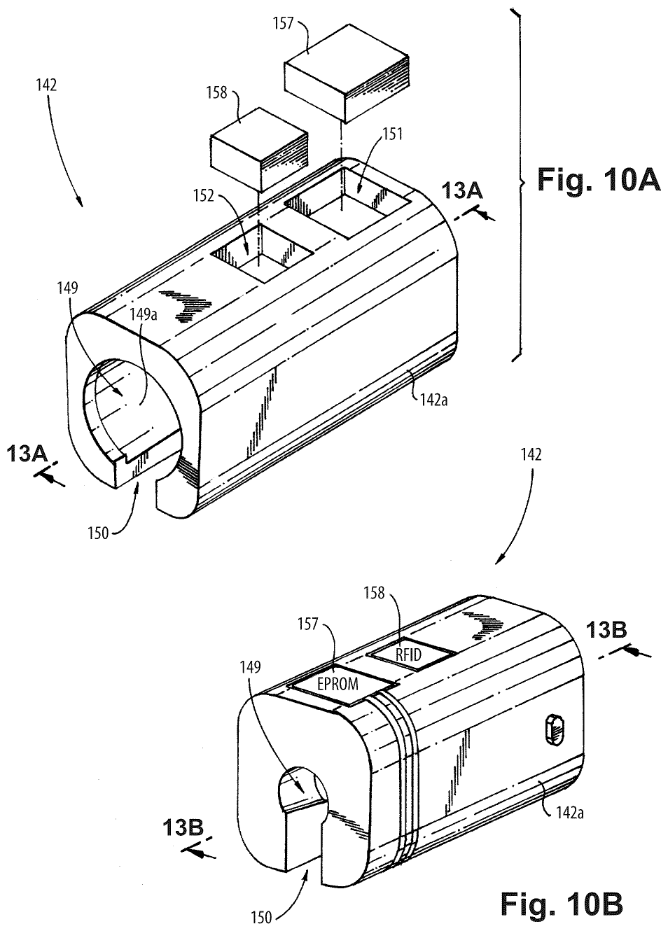

Continuing to refer to FIGS. 6-8, 10A and 10B, one or more readable electronic storage devices can be positioned within recesses 151 and 152 in the exterior 142a of the body 142. The readable electronic storage devices may also be referred to herein as the “storage devices” in the plurality and the “storage device” in the singular. The storage devices can be of many different types and sizes. As non-limiting examples, the storage devices may include EPROMS, EEPROMs and RFID type storage devices. The RFID type storage device may be in the form of an RFID tag. For ease of description, the one or more storage devices are EPROM and RFID type storage devices. In the embodiment shown, one or more electrical memory devices, e.g., EPROM 157 and/or RFID tag 158, seen in FIGS. 10A and 10B, are positioned on or in the body 142 of the AAE 140. In the embodiment shown, an EPROM 157 is within a recess 151 of the body 142, and the RFID tag 158 is positioned within a recess 152 of the body 142.

As described above, the second portion 144 of the locking member 141 is configured to fit within the opening 149 of the body 142 to form the AAE 140, as shown in FIGS. 6-8, where the locking member 141 is movably, e.g. rotatably, coupled to the body 142. The body 142 and the locking member 141 may be mechanically held together such as by using one or more notches or grooves position on the interior wall surface 149a of the body 142 and one or more corresponding ribs 145 on the exterior wall surface of the second portion 144 of the locking member 141. In another embodiment, the body 142 and the locking member 141 may be mechanically held together using one or more notches in the exterior wall surface of the second portion 144 of the locking member 141 and one or more corresponding lips or ridges in the interior wall surface 149a of the body 149. The operation of the AAE 140 according to the present disclosure is similar to that shown in FIGS. 4 and 5. Initially, a cable 101a, e.g., a fiber optic cable, of the cable assembly 101 is inserted into the opening of the AAE 140, which is similar to opening 112a of the AAE 112, so that the cable 101a is within the hollow portion of the AAE 140, which is similar to the hollow portion 117 of the AAE 112. Then, either the body 142 can be rotated relative to the locking member 141 or the locking member 141 can be rotated relative to the body 142 so that the slots 146 and 150 begin to move out of alignment. When the locking member 141 is sufficiently rotated so that the slots 146 and 150 are no longer in alignment, seen in FIG. 6, the cable 101a is held within the hollow portion of the AAE 140. More specifically, by having the slots 146 and 150 out of alignment, the opening in the AAE 140, which is similar to opening 112a in the AAE 112, is at least partially blocked by the second portion 144 of locking member 140, as seen in FIG. 6A.

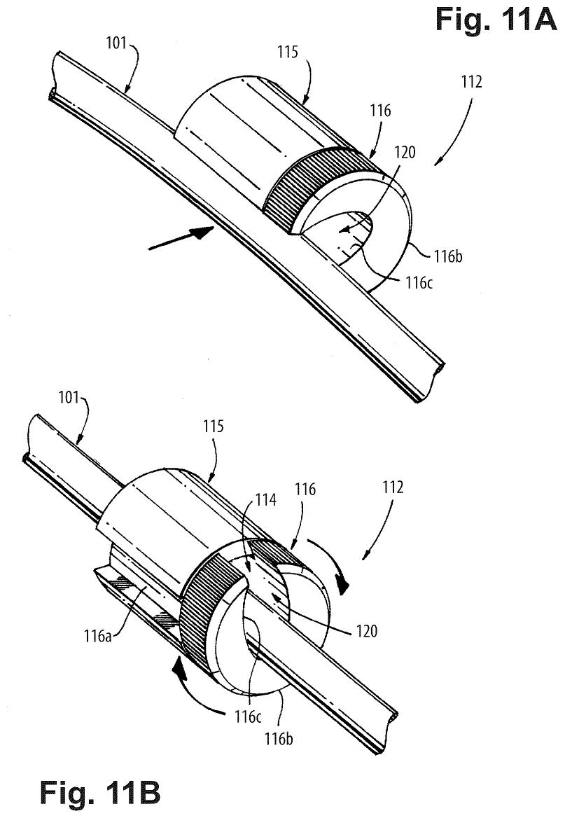

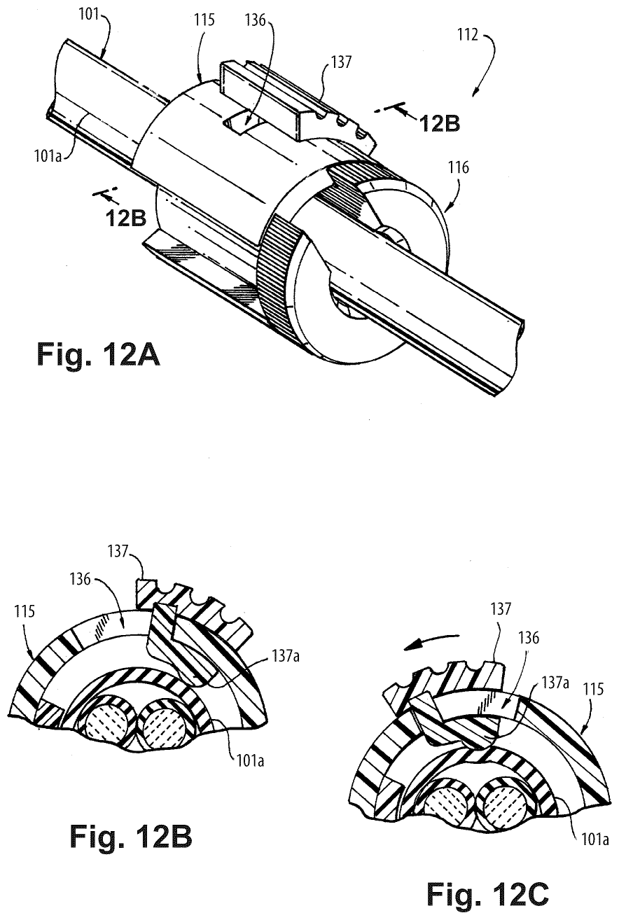

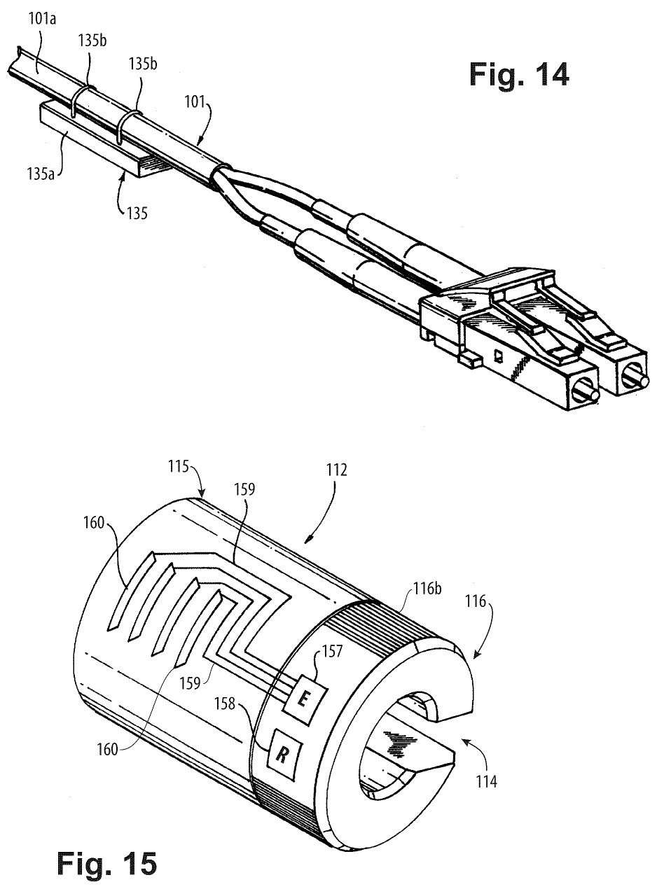

Referring now to FIGS. 11A and 11B, an embodiment where an AAE 112 or 140 can be securely connected or coupled to the cable 101a of the cable assembly 101 is depicted. As shown in FIG. 1, the AAE 112 is loose around the cable 101a so that the AAE 112 can be moved along the cable 101a from one location on the cable assembly 101 to another location on the cable 101a, as shown by the arrows in FIG. 1. To secure the AAE 112 to a selected location on the cable 101a, a cable tightening structure or mechanism may be used. An exemplary embodiment of a cable tightening mechanism according to the present disclosure is shown in FIGS. 11A and 11B with reference to AAE 112. In this exemplary embodiment, locking the AAE 112 in a fixed position on the cable 101a is achieved using a mechanical structure within the hollow inner portion 120 of the locking member 116. More specifically, the inner wall 116c of the locking member 116 can be shaped so that when the locking member 116 is further rotated, clockwise or counterclockwise as determined by the shape of the inner wall 116c, relative to the body 115, the cable 101a is wedged against the inner wall 116c of the locking member 116 causing the cable 101a to be held in the fixed position on the cable. While FIGS. 11A and 11B show one exemplary configuration to tighten the AAE 112 or 140 in a fixed position on the cable 101a, there can be many different techniques to tighten the AAE 112 or 140 in a fixed position on the cable 101a. For example, FIGS. 12A-12C show another exemplary embodiment for tightening the AAE 112 or 140 in a fixed position on the cable 101a. In this embodiment, the AAE is AAE 112, and the body 115 may include an opening 136 in which a button 137 can be toggled in the opening 136 such that in one position the button 137 can cause a detent or rib 137a to apply a force against the cable 101a causing the cable to be wedged between the detent 137a of the button 137 and the inner wall 116c of the locking member 116, and in the other position the detent 137a is moved so that the detent does not wedge the cable 101a against the inner wall 116c so that the cable 101a is free to move along the cable 101a. FIGS. 13A-13C show another exemplary embodiment for tightening the AAE 112 or 140 in a fixed position on the cable 101a. For this embodiment, the technique to tighten the AAE in a fixed position on the cable 101a is described with the AAE 140. In this embodiment, the one or more lips or ribs 145 can ride along a tapered inner wall 149a of the body 142 causing the one or more slots 153 in the locking member 141 of the AAE 140 to flex inwardly, as shown by the arrows in FIG. 13C, so that the second end 144b of the locking member 142 can grip the cable 101a to maintain the AAE 140 in a fixed position relative to the cable 101a. FIG. 14 shows another exemplary embodiment for tightening an AAE 135 in a fixed position on the cable 101a. In the embodiment of FIG. 14, the AAE 135 may include a body 135a and one or more hooks 135b that affix the body 135a to the cable 101a. The hooks 135b may be spring actuated, such that the hooks 135b open when depressed and close via the action of the spring.

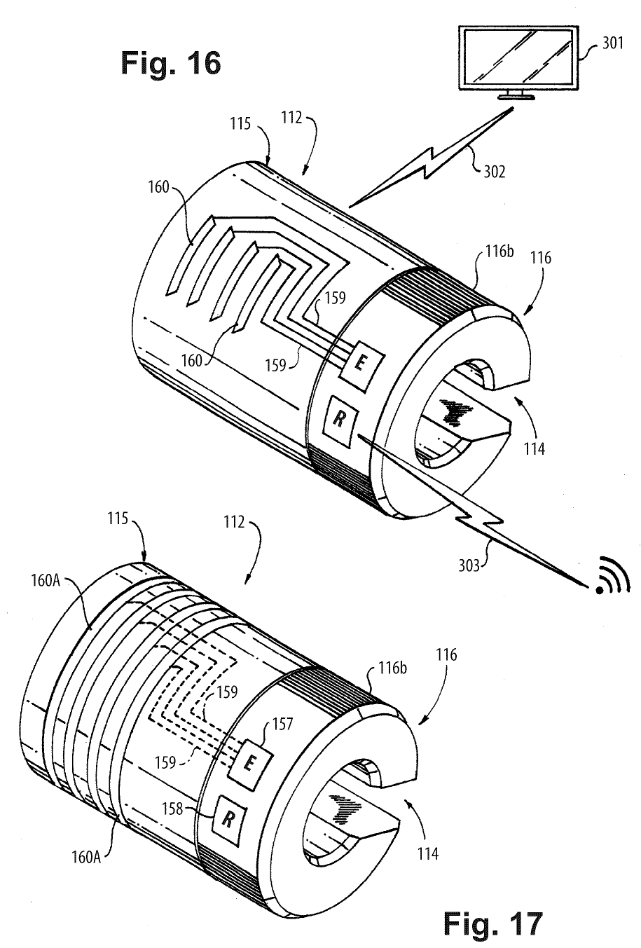

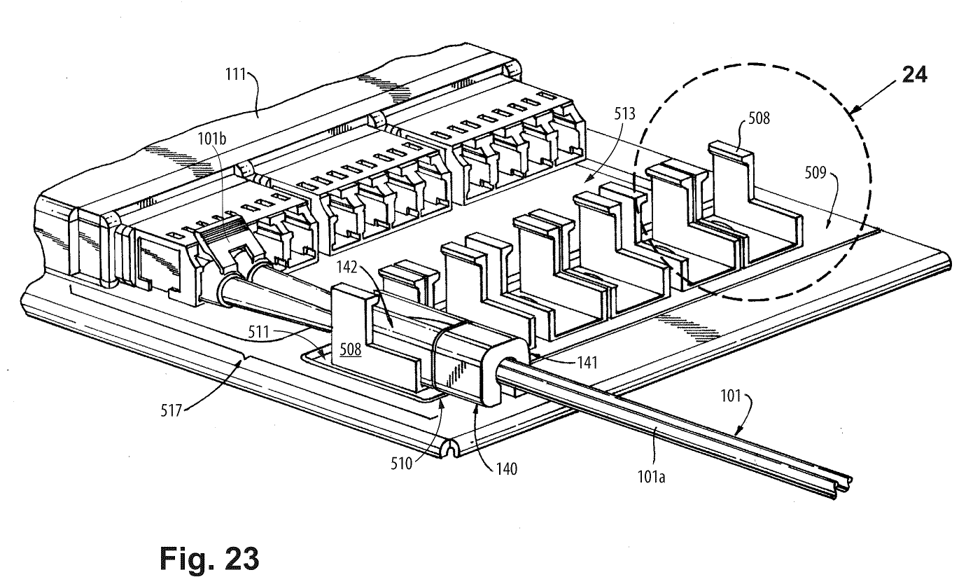

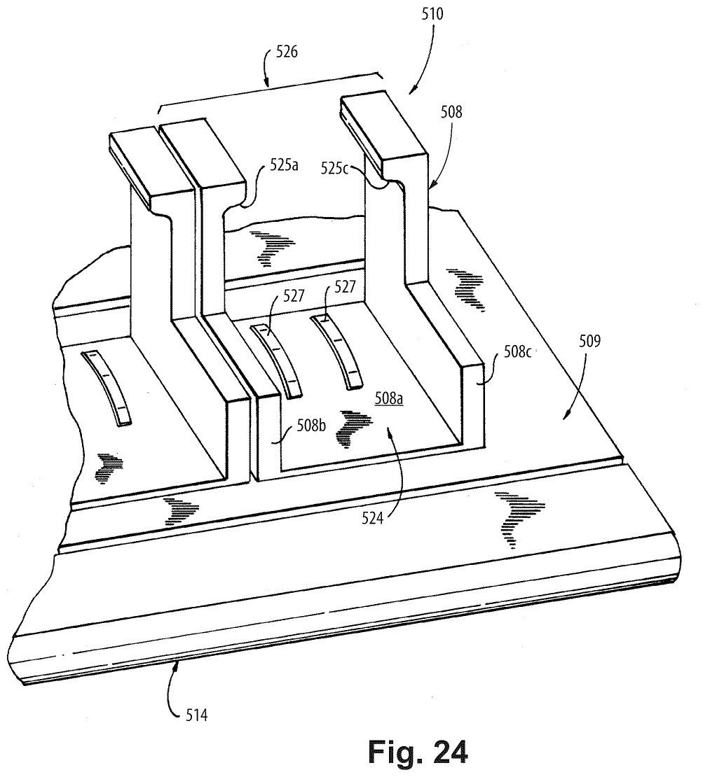

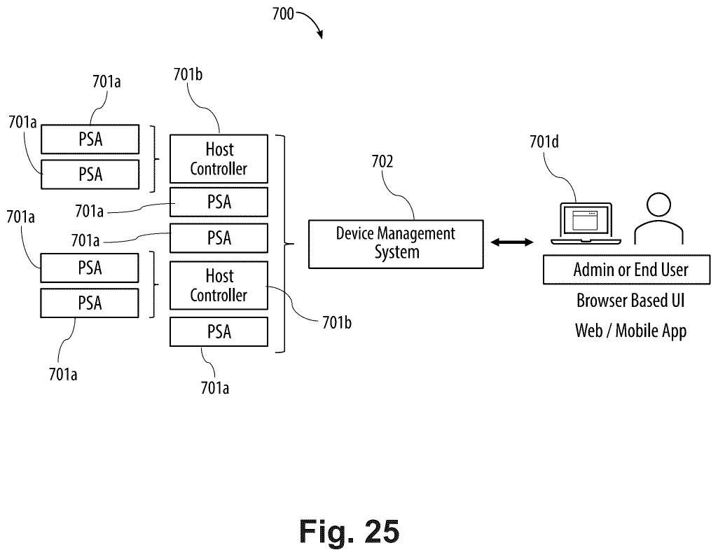

Referring now to FIGS. 15-16, another exemplary embodiment of electronic components that may be included in the AAEs of the present disclosure, e.g., AAE 112, 140 or 135. For ease of description, the electronic components that may be included in the AAEs according to the present disclosure are described in connection with the AAE 112. The electronic components include, for example, one or more electronic readable storage devices and one or more electrical contacts. Non-limiting examples of the one or more readable storage devices include EPROMS, EEPROMS and/or RFID tags. In the exemplary embodiment of FIG. 15, the electronic components are electronic readable storage devices that include EPROM 157 and RFID tag 158, and the electrical contacts 160 are electrically connected to the electronic readable storage devices via electrical leads 159. The one or more electrical contacts 160 are electrically connected to an external device so that the AAE 112 can transfer information stored on the electronic readable storage devices, e.g., EPROM 157 and RFID tag 158, to an external computer system for processing. The electrical contacts 160 can also be used to store information on the electronic readable storage devices, e.g., EPROM 157 and/or RFID tag 158. For example, the contacts 160 can then be connected to other electrical contacts located on, for example, an AAE adapter 508, seen in FIG. 25. The AAE adapter 508 may be a socket where an AAE 112 can be housed or held in position relative to a network device 111, seen in FIG. 23, that can be mounted in a cabinet or rack in a data network. The AA adapter 508 includes one or more electrical contacts 527, seen in FIG. 25, that enable communication between the AAE 112 and network devices 111. In the example here, information stored in EPROM 157 is transported over electrical leads 159 to the contacts 160. Information at the contacts 160 can then be communicated or transported to a network device 111 via the one or more electrical contacts 527 and in turn to a computer which can use the information that was stored in the EPROM 157. FIG. 16 also shows an RFID tag 158 that can store information and can wirelessly communicate with an external computer and transmit to the external computer information stored on the RFID tag 158. The RFID tag 158 can communicate with the external computer using, for example, a radio frequency identification (RFID) reader or near field communication (NFC) technology. The information stored in EPROM 157 and/or RFID tag 158 may include, for example, identification information associated with the AAE 112 that may include a unique identifier to the AAE 112. The information may be the same between the two AAEs on a particular AA adapter 508, or the information stored on each AAE on the same AA adapter 508 may be different. Information may be stored in the electronic readable storage devices, e.g., EPROM 157 and/or RFID tag 158, during the manufacturing process or stored at a time different than at manufacturing, such as by a technician in the field.

FIG. 16 also depicts a computer system 301 representing a computer, a mobile device, an application, software, and media which can communicate with the AAE 112. Each device in this data network can have one or more AAEs, e.g., AAE 112, 140 and/or 135, so that the computer would know the existence of each network device or datacenter device and all the cables assemblies 101 interconnecting each device. The AAE 112, 140 and/or 135 can have a connection to the electronic readable storage devices, e.g., the EPROM 157, and to the computer system 301. Also, the AAE 112, 140 and/or 135 can communicate with the computer system 301 using known wireless connectivity 303.

Referring to FIG. 17, another exemplary embodiment of an AAE of the present disclosure is shown. The AAE according to this exemplary embodiment is similar to the AAE 112 described above, such that like features will have the same identifier. However, in this exemplary embodiment, the contacts 160A extend around the circumference of the body 115 of the AAE 112. In addition, conductive leads 159 forming the electrical connection between the one or more contacts 160A and the electronic readable storage devices, e.g., the EPROM 157, may at least partially extend along the outer surface of the locking member 116 and along an inner surface of the body 115.

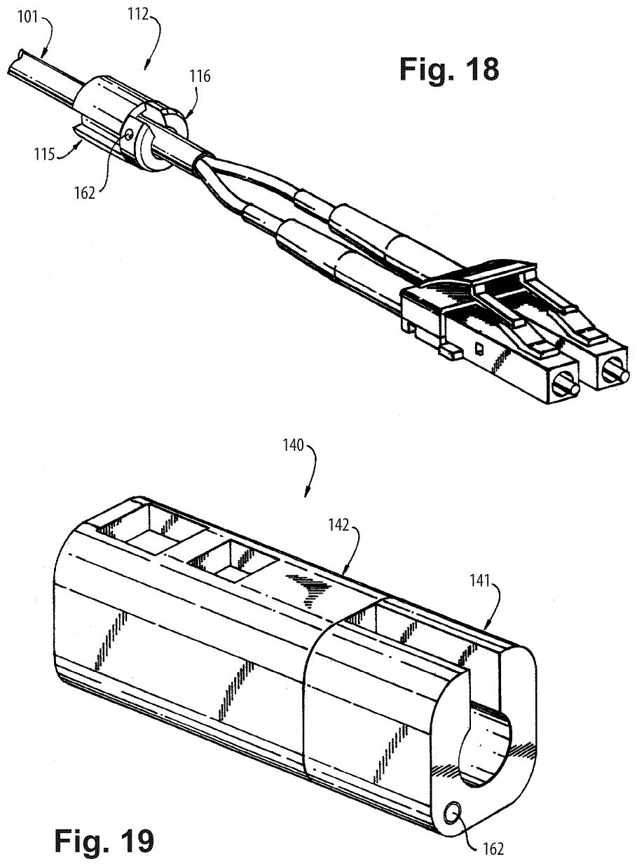

FIGS. 18 and 19 show additional exemplary embodiments of AAEs of the present disclosure. In these exemplary embodiments the AAEs 112 and 140 include one or more indicators 162 included on the locking members and/or the body. For example, in the embodiment of FIG. 18, the locking member 116 includes the indicator one or more 162, and similarly, in the embodiment of FIG. 19, the locking member 141 includes the one or more indicators 162. The one or more indicators 162 may be, for example, illuminating indicators, audio indicators, haptic indicators and/or a combination of illuminating, audio and/or haptic indicators. The one or more illuminating indicators 162 may be light emitting diodes (LED). Each of the one or more LED indicators 162 may include one or more LED light colors, where each color represents a different purpose. In another embodiment, the one or more LED indicators 162 may be made as translucent devices which shows light and color indications at a larger size. An exemplary purpose for the one or more indicators 162 is to be able to identify an AAE, e.g., AAE 112, 135 or 140, attached to a cable 101a and thus the cable 101a when an indicator signal is present, e.g., when an LED indicator 162 is illuminated. One use case of this capability is that the device management system (DMS) can instruct the one or more indicators 162 on an AAE, e.g., AAE 112, 135 or 140, attached to a particular cable assembly 101 to activate. The activated indicator or indicators 162 can then be seen (or in the case of an audio indicator heard) by a user so that the user can more easily find the cable assembly 101 from a large number of cable assemblies in the same location, or a large number of cables 101a connected to ports in a network device, without having to read paper labels attached to the cable assembly for identification.

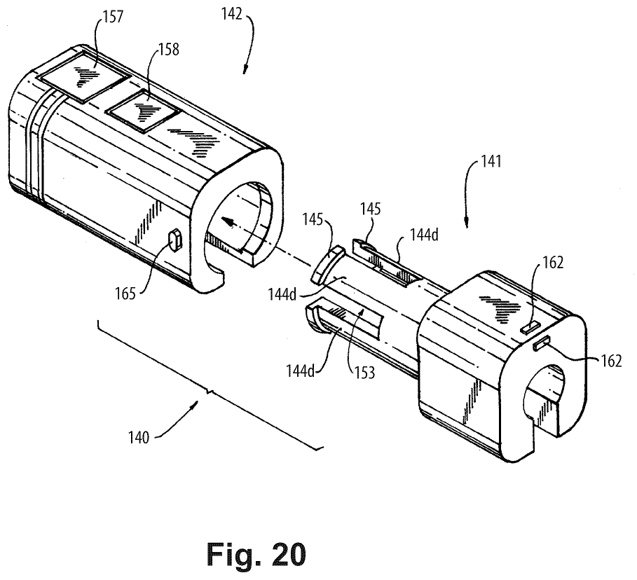

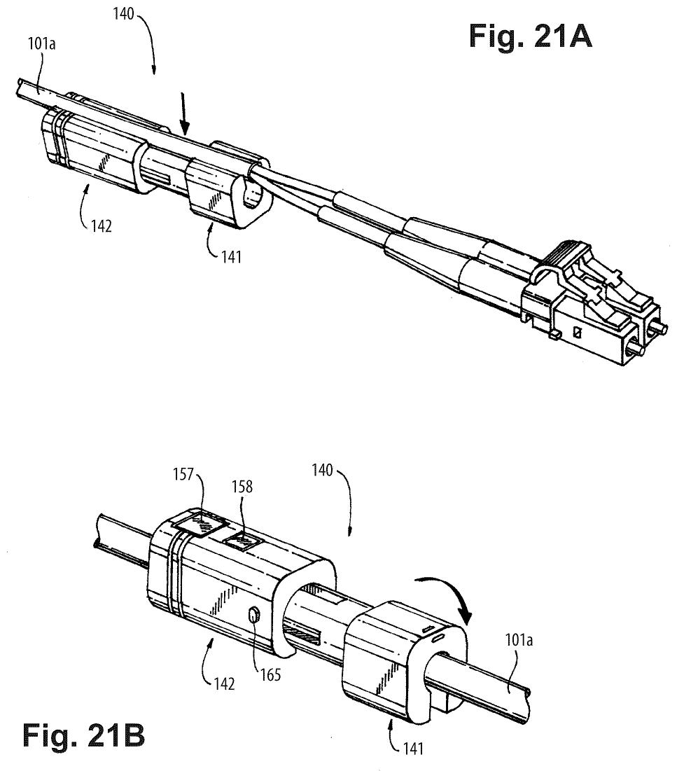

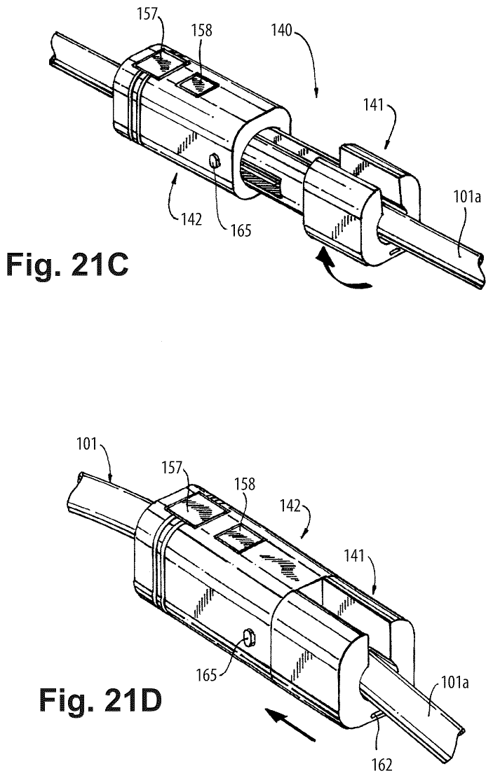

Referring to FIGS. 21A-21D a sequence for attaching an AAE configured to grip a cable to maintain the AAE in a fixed position on a cable is shown. For this exemplary embodiment, the AAE is AAE 140. As described above, the AAE 140 can be constructed as two separate parts, the locking member 141 and the body 142. Initially, the locking member 141 is partially inserted into the body 142 so that the slot 147 in the locking member 141 is aligned with the slot 150 in the body 142 as shown in FIG. 21A. The AAE 140 is then placed onto the cable 101a as shown in FIG. 21A, and the locking member 141 is rotated so that the slot 147 in the locking member 141 is no longer aligned with the slot 150 in the body 142 as shown in FIGS. 21B and 21C. Rotating the locking member 141 couples the AAE 140 to the cable 101a. To fix the position of the AAE 140 to a location on the cable 101a, the locking member 141 is further inserted into the body 142 until the end 143b of the first portion 143 of the locking member 141 contacts or is in close proximity to an end of the body 142, seen in FIG. 21D, so that the ribs 154 on the fingers 144d, seen in FIG. 20, flex inwardly. Flexing the fingers 144d inwardly causes the fingers 144d to grip the cable 101a. In addition, ribs 149b, shown in FIG. 13B, interact with the ribs 145 extending from the fingers 144d to secure the locking member 141 to the body 142.

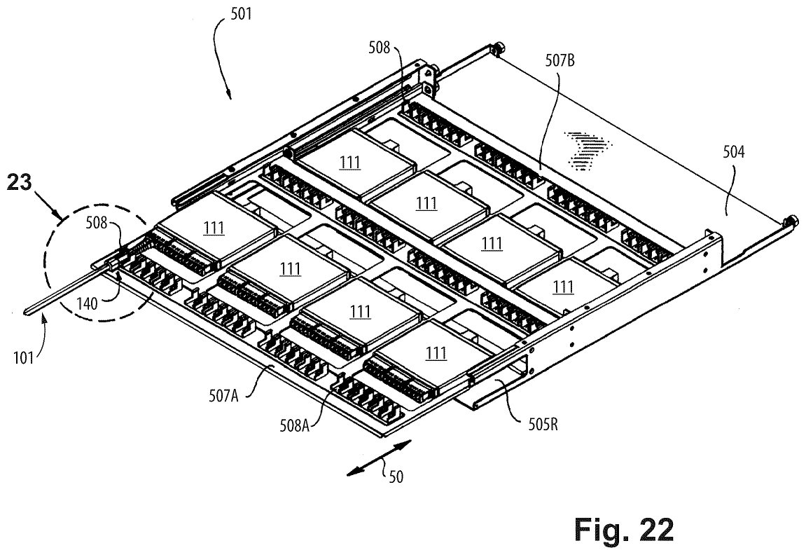

FIG. 22 is an exemplary embodiment of a network device chassis or housing 501 that can be installed in a rack or cabinet in a data network. For ease of description, the network device chassis or housings may also be referred to herein as the “chassis 501.” The dimensions of the chassis 501 can be of any size from a horizontal direction and/or a vertical direction. In the horizontal direction, the most commonly sized chassis is referred to in the industry as a 19″ rack mountable chassis. A 19″ rack mountable chassis is usually installed in a cabinet or rack which is normally 24″ in width. A 24″ cabinet or rack can hold a plurality of 19″ rack mountable chassis. The vertical height in the industry typically starts from one (1) rack unit (RU), which is about 1.75″ in height and can increase in height to, for example, 2 RU, 3 RU, 4 RU and higher. The chassis 501 shown in FIG. 22 is a one RU chassis. The chassis 501 has a front half 502 and a rear half 503. The chassis 501 may include an extension member (not shown) that may be formed into a front and/or rear of the chassis or can be attached to the front and/or rear of the chassis 501. The extension member may be used as a place where cables 101a of cable assemblies 101 can be mounted to the chassis 501 that can be managed and/or protected from damage. The extension member may be configured and dimensioned so that cables 101a can be routed on the sides 505L and 505R and sides 506L and 506R in a protected fashion.

Continuing to refer to FIG. 22, an exemplary embodiment of an interior of the chassis 501 is shown. Within the chassis 501 are one or more network devices 111 mounted to one or more movable trays. In the exemplary embodiment shown, the network devices 111 are fiber optic patch panels. However, the network device 111 may be any other network device, including servers, switches and storage units. In this embodiment, the chassis 501 has a top tray 507A and a bottom tray (not shown), where each tray includes one or more network devices 111. For larger RU chassis, e.g., 2 RU, 3 RU and 4 RU chassis, there may be more than two trays. The tray 507A has been pulled at least partially out of a chassis revealing the network devices 111. With the chassis 501 installed in a cabinet or rack, the tray 507A can slide out permitting technicians to easily work on the network devices 111 within the chassis 501. FIG. 23 illustrates a cable assembly 101 connected to one of the network devices 111 and the AAE 140 is held in place by an AA adapter 508 forming a portion of a tracking apparatus 510 in front of each network device 111.

Referring to FIGS. 23 and 24, an exemplary embodiment of the cable tracking apparatus 510 on the front and rear of tray 507A is shown. The cable tracking apparatus 510 includes one or more adapter board assemblies 509 mounted within a slot 511 within the tray 507A. Each adapter board assembly 509 may include one or more AA housings 508, which may also be referred to as the AA adapter 508. Cassette finger slots 513 are designated spaces that permit easier insertion and removal of cables into the network device 111. As noted, FIGS. 23 and 24 depict an example of one use-case in which the cable tracking apparatus 510 used with a fiber optic patch panel network device 111 transforms the network device 111 into an intelligent patch panel systems with ability to manage and control the patching modules and cables attached to network device 111. The AAE 140 is snapped into one of the AA adapters 508 and the cable connector 101b of the cable assembly 101 is plugged into the network device 111. As shown, a cable assembly 101 has a cable 101a connected to a connector 101b and an AAE 140 attached to the cable 101 is attached to the AA adapter 508.

In this exemplary embodiment, the AA adapter housing 508 includes a base 508a, a first leg 508b and a second leg 508c. The first leg 508b and second leg 508c extend away from the base 508a such that the legs are substantially perpendicular to the base 508a. The base 508a and the legs 508b and 508c form an AAE opening 524. The AAE opening 524 is configured and dimensioned to receive an AAE, e.g., AAE 112, 135 or 140. At least a portion of the legs 508b and 508c, at least a portion of the AAE opening 524 and a pair of device latch arms 525a and 525b form an AAE latching portion 526. More specifically, the AAE latching portion 526 includes the first device latch arm 525a extending from the first leg 508b of the adapter housing 508, and the second device latch arm 526b extending from the second leg 508c of the adapter housing 508. For ease of description, the latch arms 525a and 525b may also be referred to as the latch arms 525. The latch arms 525 extend into the AAE opening 524 in the adapter housing 508 and are configured and dimensioned to grip and hold an AAE, e.g., AAE 112, 135 or 140, within the AAE opening 524. The base 508a of the adapter housing 508 may include one or more electrical contacts 527 that are configured to electrically contact or connect to contacts, e.g., electrical contacts 160 shown in FIGS. 10B and 15-17, on an exterior surface of an AAE 112, 135 or 140 when the AAE is inserted into the AAE opening 524.

Referring now to FIGS. 25-36, an exemplary embodiment of an asset management system 700 according to the present disclosure is shown. In FIG. 25, the asset management system 700 may include one or more panel sensor aggregators (PSA) 701a. The one or more panel sensor aggregators 701a are electronic devices that are attached to a panel and are used to collect sensor data from one or more AAEs. The PSA's may be in communication with one or more host controllers 701b. The one or more host controllers 701b are hardware devices that are attached to a cabinet or rack in a data network and are used to aggregate the electronic devices, e.g., the PSA's. It is noted that one or more PSA's may also be attached to a cabinet or rack in a data network. The asset management system 700 may also include the device management system (DSM) 702. The DSM 702 may be a virtual or hardware appliance where the asset management system 700 may reside. One or more user interface devices 701d may be used to permit a user to access the asset management system 700 in the DMS 702. In the example of FIG. 25, the software can be accessed via a web browser or a mobile app.

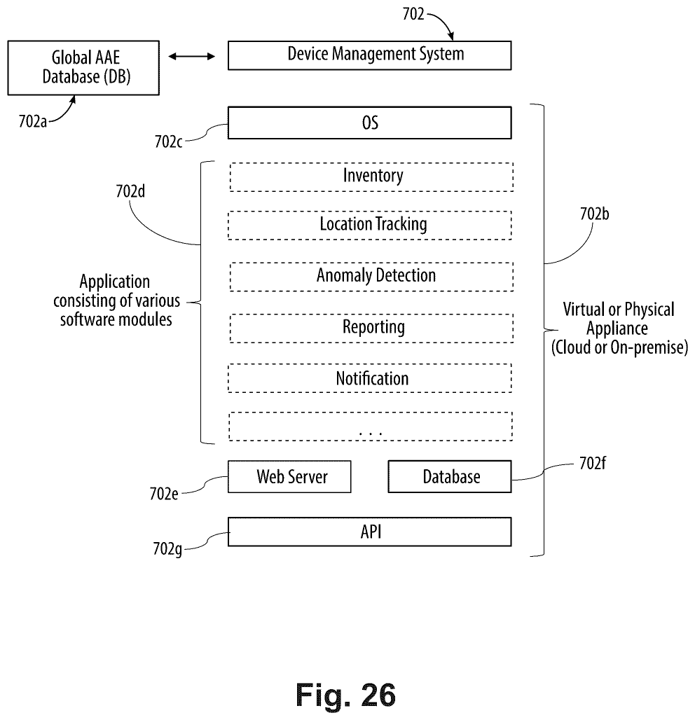

Referring to FIG. 26, an exemplary embodiment of the device management system (DMS) according to the present disclosure is shown. The DMS 702 includes a global AAE database 702a that may contain, for example, a listing of all known AAEs, e.g., AAEs 112, 135 and 140. The DMS 702 may also include one or more additional software components 702b. In the exemplary embodiment shown, the DMS software modules 702b include an operation system (OS) module 702c, software modules 702d, a web server module 702e, a database module 702f and an application program interface (API) 702g layer. Non-limiting examples of the various software modules 702d include an inventory module, a location tracking module, an anomaly detection module, a reporting module and a notification module. The DMS 702 is user accessible via the application program interface (API) layer 702g. Having the DMS 702 accessible via the application program interface (API) 702g layer permits user access to the AAE database 702a so that users have the ability to look up information about one or more AAEs under management by the DMS 702. For example, users would be able to retrieve information, e.g., one or more properties of a cable assembly 101, from remote locations. Non-limiting examples of the information that users could retrieve include the length of the cable assembly, the type of optical fibers within the cable, the location of the cable, etc.

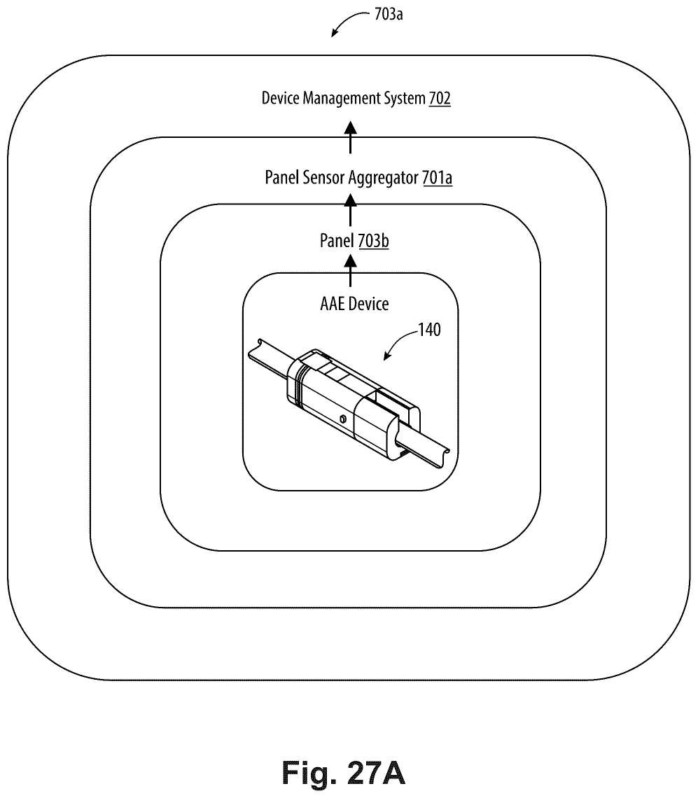

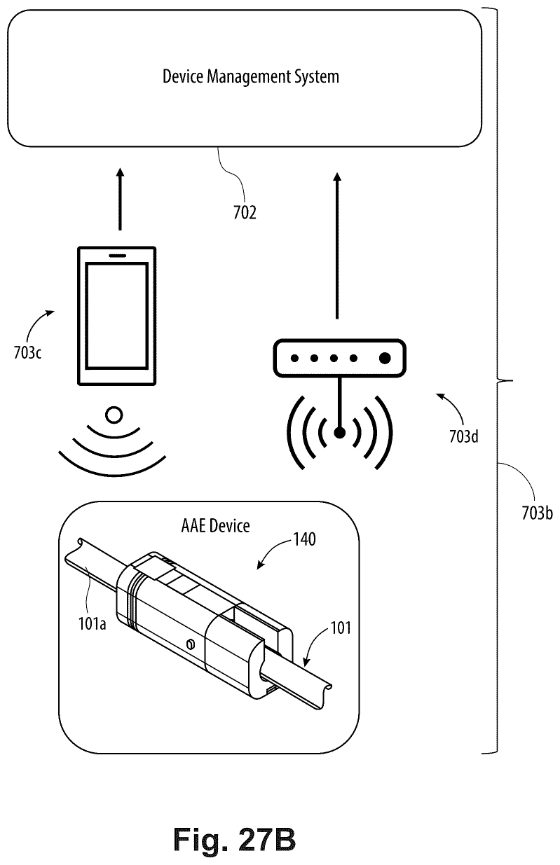

Referring to FIGS. 27A and 27B, are schematic representations in which an AAE, e.g., AAE 112, 135 and/or 140, can interact with the network asset management system 700 according to the present disclosure is shown. As shown in FIG. 27A, an exemplary data flow 703a of AAE information is shown for situations in which an AAE, here AAE 140, is physically attached to a panel of a network device 111 using, for example, a wire holding the AAE to the network device, hook and loop fasteners, and adhesives. Sensor data from the AAE 140 flows through the panel circuitry 703b to the panel sensor aggregator (PSA) 701a. The PSA 701a then transmits the information to the DMS 702 for processing. As shown in FIG. 27B, an exemplary data flow 703b of AAE information is shown for situations in which an AAE, here AAE 140, is not physically attached to a panel of a network device 111. In this exemplary embodiment, the AAE 140 is attached to a cable assembly 101. In this embodiment, the AAE 140 can be read wirelessly with a mobile device 703c or with a stationary wireless transceiver 703d. The mobile device 703c or stationary wireless transceiver 703d then transmits the AAE information to the DMS 702 for processing.

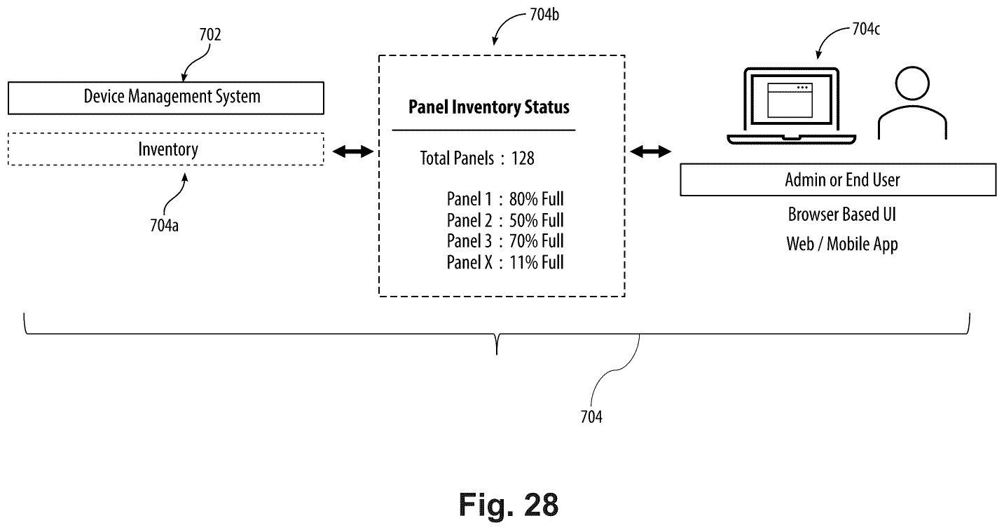

Referring to FIG. 28, a schematic representation showing how AAE information from one or more AAEs can be used in the software system of the present disclosure and presented to end users. In this exemplary embodiment, the inventory module 704a of the DMS 702 is used. AAE information 704b is retrieved by the DMS 702 from the inventory module 704a. The AAE information in this example is for various panels 703b. The capacity of the number of AAEs, e.g., AAEs 112, 135 and 140, is shown in 704b, and is measured by a percentage of total capacity of a panel of the network device 111 and the number of AAEs are detected within the panel of the network device. It is noted that each detected AAE, e.g., AAE 112, 135, 140, is typically associated with one port on the panel of the network device. The retrieved AAE information can then be displayed to a user in a graphical or text format within a web browser or mobile app at 704c.

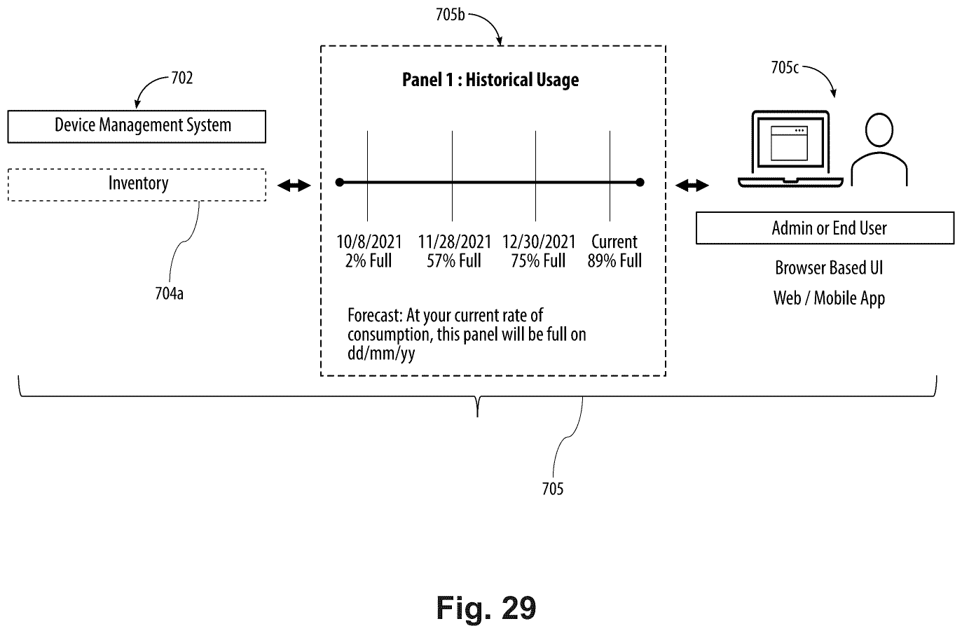

Referring to FIG. 29, a schematic representation of another exemplary embodiment showing how AAE information from one or more AAEs can be used in the software system of the present disclosure and presented to end users. In this exemplary embodiment, the inventory module 704a of the DMS 702 is again used. AAE information 705b is retrieved by the DMS 702 from the inventory module 704a. The AAE information in this example is for a panel 705b of a network device 111. In this example, the AAE information is the panel's historical usage information based on AAE information. This historical usage information can also be used to forecast future usage. The retrieved historical usage information can then be displayed to a user in a graphical or text format within a web browser or mobile app at 705c.

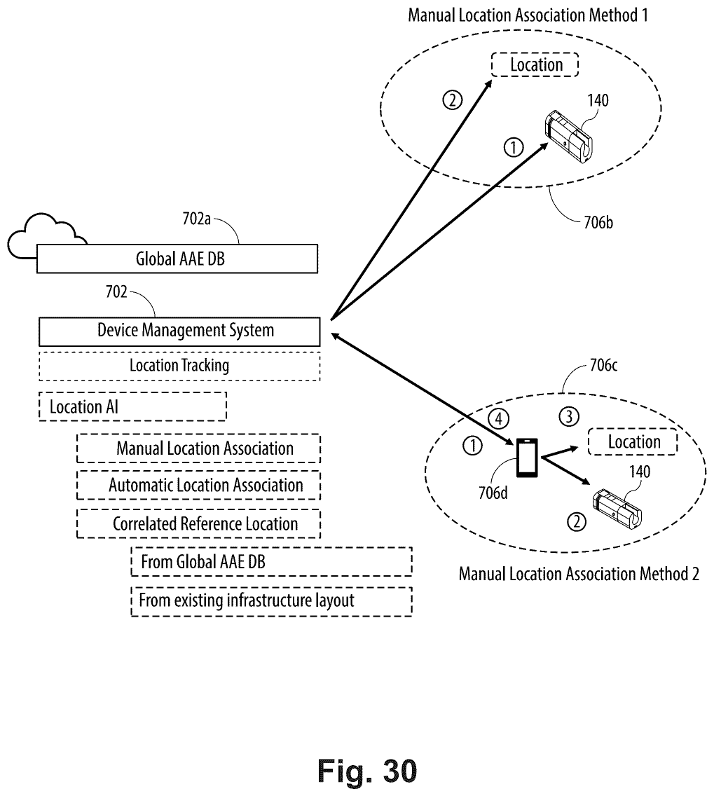

Referring to FIG. 30, a schematic representation of another exemplary embodiment showing how AAEs, e.g., AAEs 112, 135 and 140, can be tracked with the DMS 702. In this embodiment, the location tracking module 706a of the DMS 702 is used. The DMS 702 includes a number of methodologies to track an AAE's location within a data network. A first methodology is through a manual location association 706b. In the first manual location association method, step 1 is to use the DMS 702 to look-up an AAE, and step 2 is to manually enter the AAE's location into the DMS, e.g., SCJ-100-1-1, San Jose, Building 100, Floor 1, Room 1. A second methodology is also through a manual location association 706c that is initiated using a mobile device 706d. Step 1 is to login to the DMS 702 using the mobile device 706d. In steps 2 and 3, the mobile device 706d scans the AAE, here AAE 140, and stores the location of the AAE 140. In step 4, the mobile device 706d transmits the AAE information to the DMS 702 which stores the AAE information in the global AAE DB 702a.

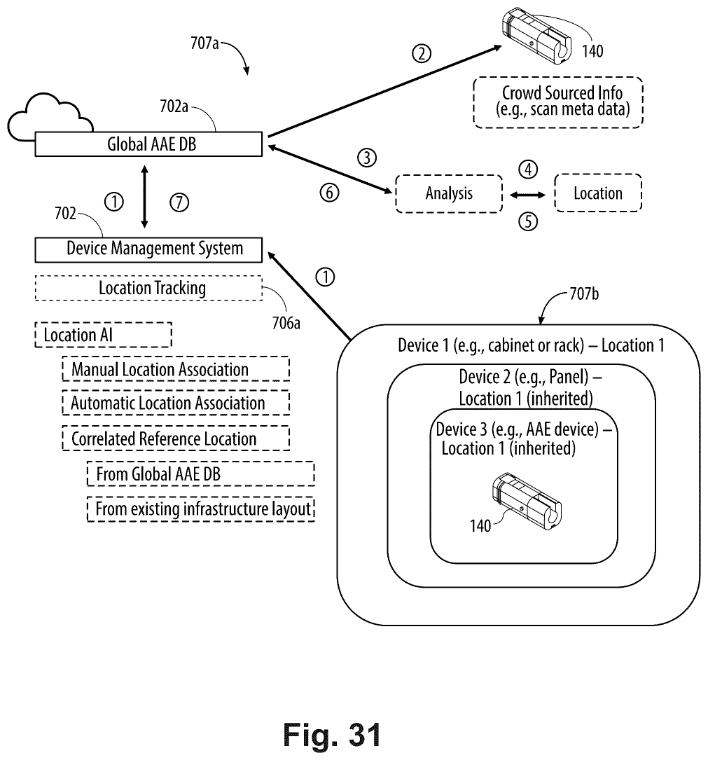

Referring to FIG. 31, a schematic representation of another exemplary embodiment showing how AAEs, e.g., AAEs 112, 135 and 140, can be tracked with the DMS 702. In this embodiment, the location tracking module 706a of the DMS 702 is used. In this embodiment, an AAE's location can be associated automatically. The DMS 702 includes a number of automatic methodologies to track an AAE's location within a data network. In the first automatic location association method 707a, step 1 is to use the DMS 702 to query the global AAE DB 702a, which is a public repository of all known AAEs, e.g., AAEs 112, 135 and 140, and derive the location of the AAE, here AAE 140. It is noted, when an AAE is scanned, certain meta data associated with the AAE are anonymized and stored in the global AAE DB 702a. For example, the meta data may include the location of the AAE 140. This information is analyzed by the DMS 702, and the best location is given. In the second automatic location association method 707b, the location of an AAE, here AAE 140, can be inherited from a higher-level device. For example, if the AAE 140 is attached to a network device, e.g., a panel, and the network device is in a cabinet or rack of a data network, then the location of the AAE 140 can be inherited or derived from the known location of the network device or from the location of the cabinet or rack of a data network.

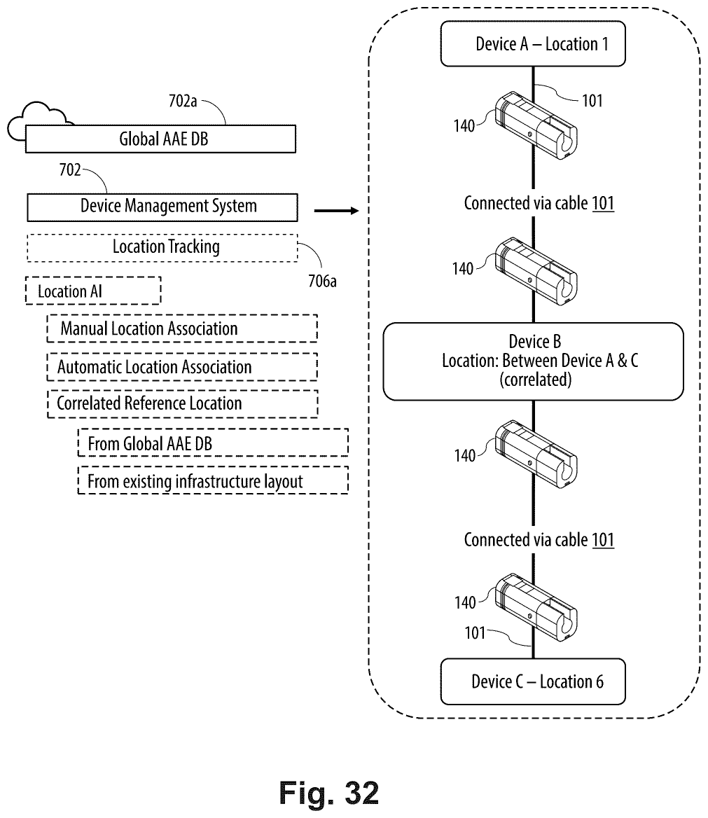

Referring to FIG. 32, a schematic representation of another exemplary embodiment showing how AAEs, e.g., AAEs 112, 135 and 140, can be tracked with the DMS 702. In this exemplary embodiment, the DMS 702 can be used to derive a correlated reference location for an AAE. In this example, three network devices 111 are connected with two cable assemblies 101. An AAE is attached at the end of each cable 101a in the cable assembles 101 so that there are four AAEs, here AAEs 140, in the connection between network device A and network device C, as shown. Cable assemblies 101 with AAEs, e.g., AAEs 112, 135 and 140, attached at each end may also be referred to as AAE enabled cables. If the location of network device A (Location 1) and network device C (Location 6) is known, the DMS 702 can use collected AAE information on the two cable assemblies 101 to make a correlated reference location for network device B, which in this example is between network devices A and C. In addition, the DMS 702 can also query the global AAE DB 702a for additional information on the AAE. For example, the DMS 702 can retrieve from the global AAE DB the length of each cable 101. This would allow the DMS 702 to infer a distance between network device A and network device B, and to infer a distance between network device B and network device C. This information can also be used by the DMS 702 to automatically generate network related documentation, such as a topology as to what cables are connected to what network devices 111.

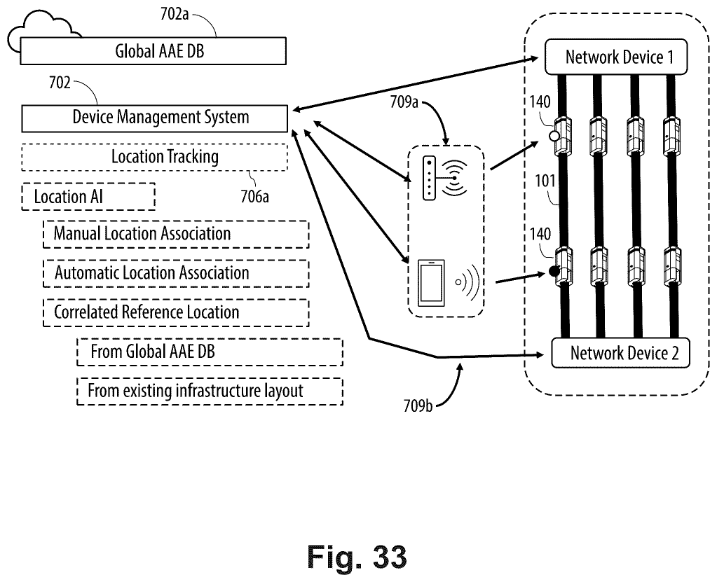

Referring to FIG. 33, a schematic representation of an exemplary embodiment showing how the DMS 702 can activate/deactivate one or more indicators on an AAE, e.g., AAE 112, 135 and 140, for the purpose of identification and location of the AAE. Non-limiting examples of the one or more indicators include visual indicators and audible indicators. A non-limiting example of a visible indicator is a light emitting diode (LED). A non-limiting example of an audible indicator is a buzzer. The first method 709a to activate/deactivate one or more indicators on an AAE, here AAE 140, involves using a wireless device 709c via radio frequency. In this example, the DMS 702 sends the unique ID of the AAE 140 to the wireless device 709c. The wireless device 709c then broadcast a signal with the unique ID with instructions to activate/deactivate its indicator, here a LED. A second method 709b to activate/deactivate one or more indicators on an AAE attached to, for example, a network device, e.g., a panel, involves the DMS 702 sending a request to the network device, e.g., network device 1 or network device 2, and the network device sends a message to the AAE 140 to activate/deactivate its one or more indicators, e.g., a LED.

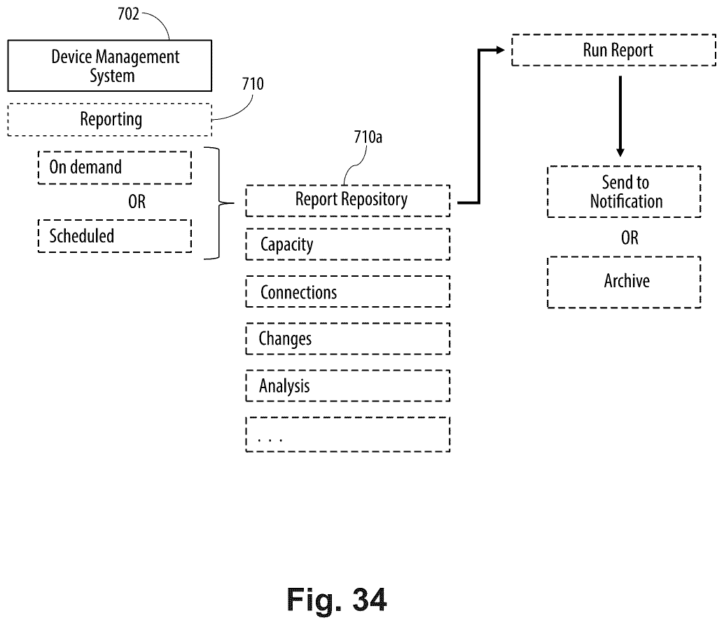

Referring to FIG. 34, a schematic representation of an exemplary embodiment showing how the DMS 702 can report information to end users using the reporting module 710 is shown. In a first example, the report can be an on-demand report that is manually initiated by a user. In a first example, the report can be a schedule report that are generated based on a schedule. The report module 710 may contain a repository of reports 710a. A user can select a type of report and can either run it manually or set it to a schedule. After a report is run, the report can either queue the report for delivery via a configured delivery mechanism, or the report can be archived in the global AAE DB 702a of the DMS 702 for future use, so that AAE information can be shared among users.

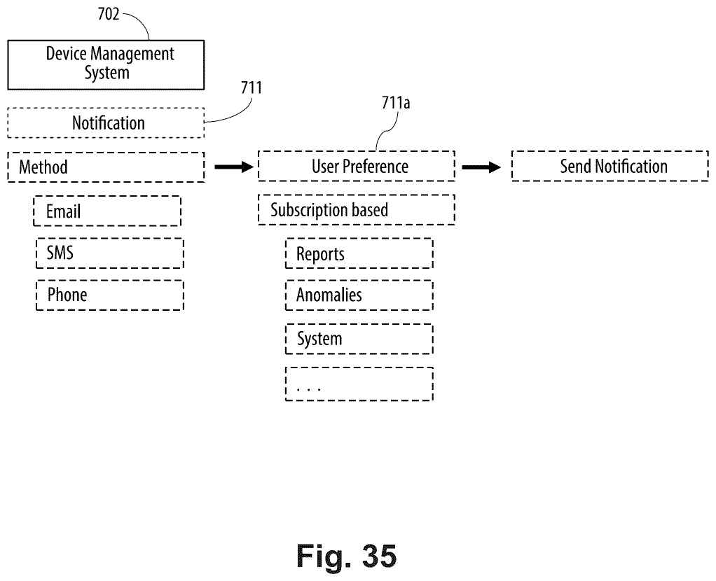

Referring to FIG. 35, a schematic representation of an exemplary embodiment showing how the DMS 702 can notify end users using the notification module 711 is shown. The notification module 711 supports various type of notification methods. For example, the DMS 702 can send notifications via email, SMS message and mobile phone. Notifications can be made on a subscription basis. Users can select user defined preferences 711a that set forth the type of activity/incidents the user would like to receive notifications about, and a notification can then be sent accordingly.

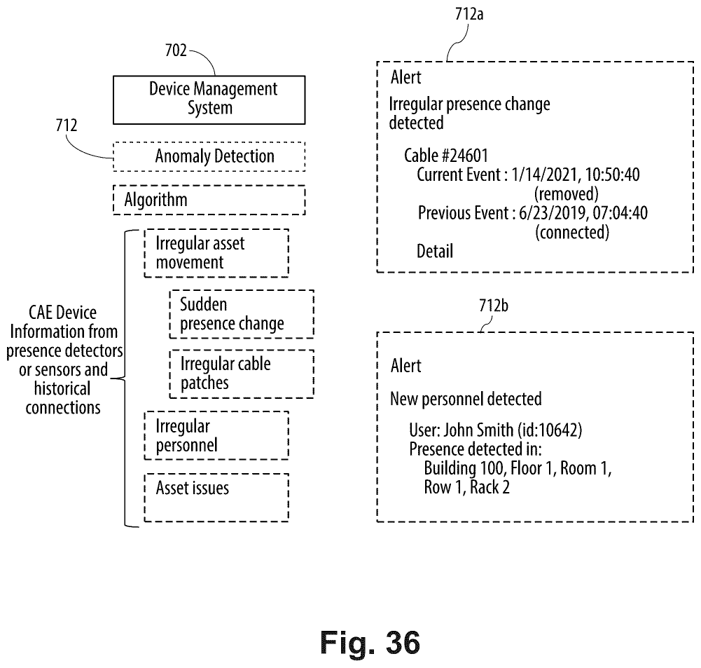

Referring to FIG. 36, a schematic representation of an exemplary embodiment showing how the DMS 702 can detect anomalies using the anomaly detection module 712 of the DMS 702 is shown. AAE information or data, such as presence detector or sensor data from AAEs, e.g., AAEs 112, 135 and 140, are run through a repository of anomaly detection algorithms. When an anomaly is detected by the algorithm an alert, e.g., alert 712a or 712b, is generated and presented to the user. This can be a text alert and/or a graphical alert. The alert can also be queued for delivery via the notification module described above.

What is claimed is:

1. A data network asset management system comprising:
a plurality of network devices;
a plurality of cable connected at least between a first network device of the plurality of network devices and a second network of the plurality of network devices; and
one or more AAE connected to each of the plurality of cables, wherein each AAE device includes a body and a locking member releasably secured to the body and movable relative to the body, the body having an outer wall and a hollow center wherein the outer wall includes an body opening extending from a first end of the body to a second end of the body, and the locking member having an outer wall and a hollow center wherein the outer wall of the locking member includes an locking member opening extending from a first end of the outer wall of the locking member to a second end of the outer wall of the locking member, and wherein when the locking member is moved relative to the body or the body is moved relative to the locking member, the body opening can be aligned with the locking member opening to form a cable opening in the AAE device configured to permit at least one of the plurality of cables to pass through the body outer wall and the locking member outer wall into the hollow center of the body and the hollow center of the locking member.

2. An AAE device for tracking assets of a data network comprising:
a body having an outer wall and a hollow center, wherein the outer wall of the body includes a body opening extending from a first end of the body to a second end of the body; and
a locking member releasably secured to the body and movable relative to the body, the locking member having an outer wall and a hollow center, wherein the outer wall of the locking member includes a locking member opening extending from a first end of the outer wall of the locking member to a second end of the outer wall of the locking member;
wherein when the locking member is moved relative to the body or the body is moved relative to the locking member, the body opening can be aligned with the locking member opening to form a cable opening in the AAE device configured to permit at least cable to pass through the body outer wall and the locking member outer wall into the hollow center of the body and the hollow center of the locking member.
